(19) United States
(12) Patent Application Publication
(10) Pub. No.: US 2010/0161463 A1
(43) Pub. Date: Jun. 24, 2010

(54) Digital register voice recorder (Digi RVR)

(76) Inventor: Lucrecia Cossette Richardson, Fernley, NV (US)

Correspondence Address: Goodman Law Center, 348 Mill Street, Reno, NV, 89501, US

(21) Appl. No.: 12/655,132

(22) Filed: Dec. 23, 2009

Related U.S. Application Data
(60) Provisional application No. 61/140,104, filed on Dec. 23, 2008.

(51) Int. Cl. G06Q 40/00; G10L 15/00; G06F 3/041

(52) U.S. Cl. 705/33; 705/41; 704/275; 345/173; 704/E11.001

(57) ABSTRACT

A portable electronic device for monitoring and tracking at least one bank account and a plurality of transactions is disclosed. The invention includes a first panel having an outer surface and an inner surface and a second panel with an inner surface. The outer surface may include a digital touch screen, a speaker and an On/Off button to interface with a user and the inner surface includes a plurality of slots designed to hold at least one electronic transaction card. The inner surface of second panel includes at least one slot for holding at a transaction document. The first and the second panel is arranged in face to face relation along a horizontal fold line to make the device compact and easy to operate. The device can be customized as a unit for singles, a unit for couples and a unit for businesses.

### CLAIM FOR PRIORITY

Under 35 U.S.C. 120 This application claims priority from application 61/140,104, a provisional application filed on Dec. 23, 2008. Said provisional application has the same inventor and owner as this application and has a confirmation number of 2117.

### FIELD OF THE INVENTION

The present invention relates generally to electronic devices for monitoring and tracking bank account activity. More particularly, the present invention relates to a digital register voice recorder (Digi RVR) designed for managing bank accounts of individuals, groups and business organizations.

### BACKGROUND

Checking accounts otherwise known as current accounts, have been used at banks by individuals, groups and business organizations to manage their financial affairs. Despite the growth of credit cards, debit cards, business, remittance & travel currency cards, automatic account debits and other special arrangements, current accounts continue to play a critical role in financial accounting all over the world.

The main challenge commonly experienced in connection with the use of checking accounts involves the maintenance of a check book register in connection with the account. This requires entering correct check information into the register, the addition of deposits and interests and the subtraction of check entries, deductions, charges etc.

Balancing the checkbook can be a tedious process. Many times receipts get misplaced and it is impossible to remember all the financial transactions that were made. If the person forgets to update the records at the end of each day, an account may become overdrawn. This results in unnecessary penalties and fees. Often, with a joint account, one spouse will make a transaction and neglect to inform the other. This causes overdraft problems and additional fees.

Business organizations that offer expense accounts may find it difficult to keep track of all their employees who are spending company funds. Relying on receipts can make the process complicated and sometimes the numbers just don't add up. In addition, balancing the books can be time consuming and frustrating. Therefore, there exists an unfilled need for a quick and accurate electronic device that may be used for monitoring bank accounts, tracking of debits and credits, designed for managing bank accounts of individuals, groups and business organizations. As such, the device would be adapted for recording all deductions, deposits, and transfers. Also, the device would be customizable to easily recall balance inquiries of different accounts and capable of paging a second device with the updated account information. The device would also be compatible with an earpiece. The device would be utilized for documenting all banking information and ultimately providing the person with a compact, simple and convenient way to monitor their bank accounts.

### SUMMARY OF ONE EMBODIMENT OF THE INVENTION

### Advantages of One or More Embodiments of the Present Invention

The various embodiments of the present invention may, but do not necessarily, achieve one or more of the following advantages:

The ability to monitor bank accounts and keep track of spending.

The ability to manage bank accounts of single individuals, groups and business organizations.

The ability to easily recall balance inquiries of different accounts and capable of paging a second device with the updated account information.

The ability to synchronize banking information with financial software on a computer through a USB (Universal Serial Bus).

The ability to electronically document all banking information and ultimately provide the person with a compact, convenient way to monitor their financial spending.

The ability to operate in two different modes that are automatic and manual.

The ability to record information regarding the amount spent, withdrawn, deductions, deposits and/or transfers using a voice recorder and/or earpiece.

These and other advantages may be realized by reference to the remaining portions of the specification, claims, and abstract.

### BRIEF DESCRIPTION OF ONE EMBODIMENT OF THE PRESENT INVENTION

In one embodiment, the invention comprises a portable electronic device for monitoring and tracking at least one bank account and a plurality of transactions. The device comprises: a first panel having an outer surface and an inner surface. The outer surface includes at least one user interfacing area, a speaker and at least one button to interface with a user and the inner surface includes a plurality of slots designed to hold at least one electronic transaction card. The invention further includes a second panel with an inner surface that includes at least one slot for holding at least one transaction document. The second panel further includes at least one slot designed to hold at least one pen. The first and the second panel is arranged in face to face relation along a horizontal fold line to make the device compact and easy to operate. The device can be customized as a unit for singles, a unit for couples and a unit for businesses. The device can optionally be configured to hold a checkbook. The device further includes a voice recorder for recording information regarding amount spent, withdrawn, deductions, deposits and/or transfers via verbal commands using the device speaker or via earpiece.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a detailed illustration of one embodiment of the present invention.

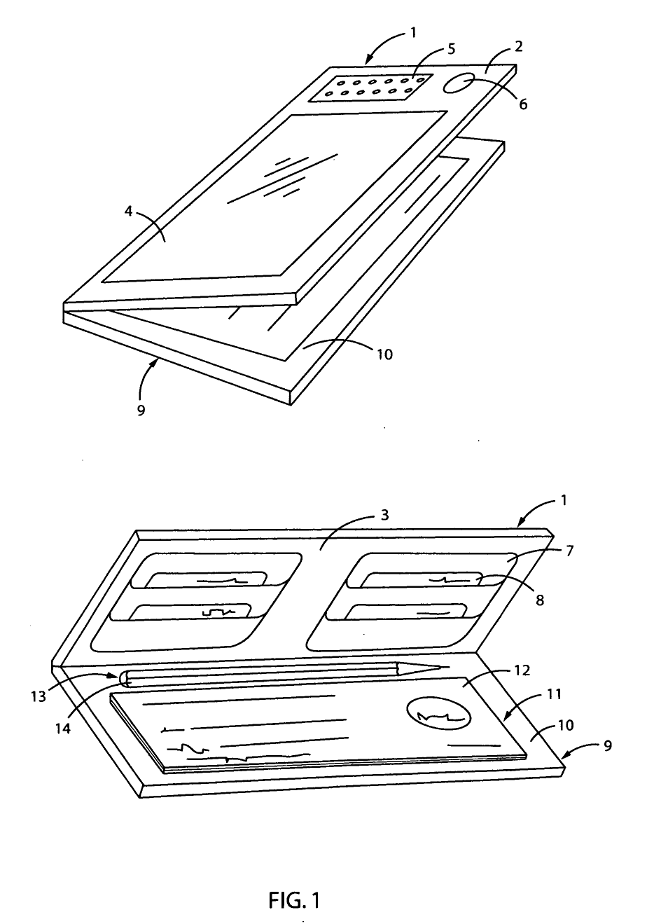

FIG. 2 is substantially a detailed illustration of one embodiment of the invention including a plurality of slots on outer and inner surface for holding at least one electronic transaction card.

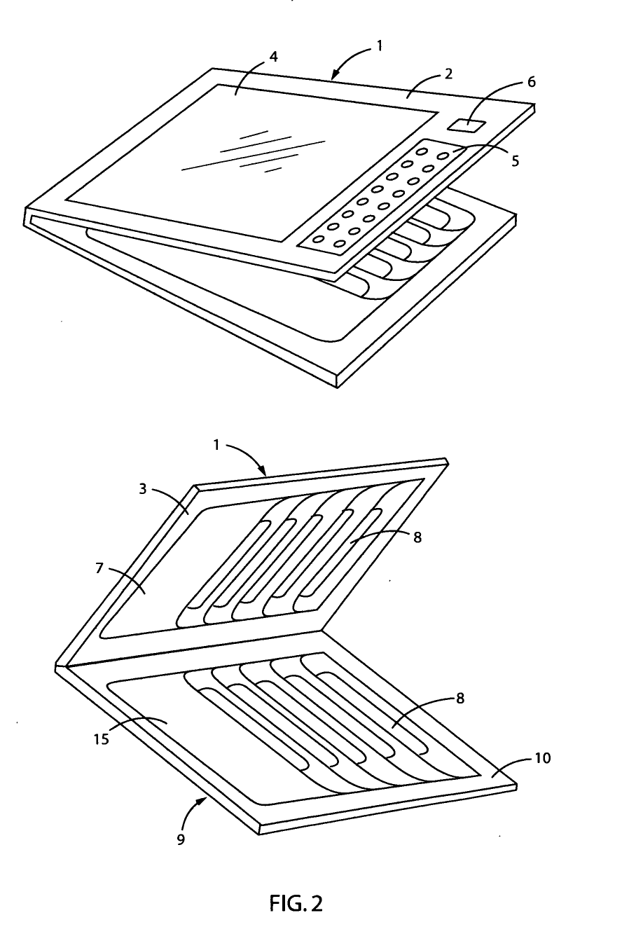

FIG. 3 is substantially a user interfacing area with different options.

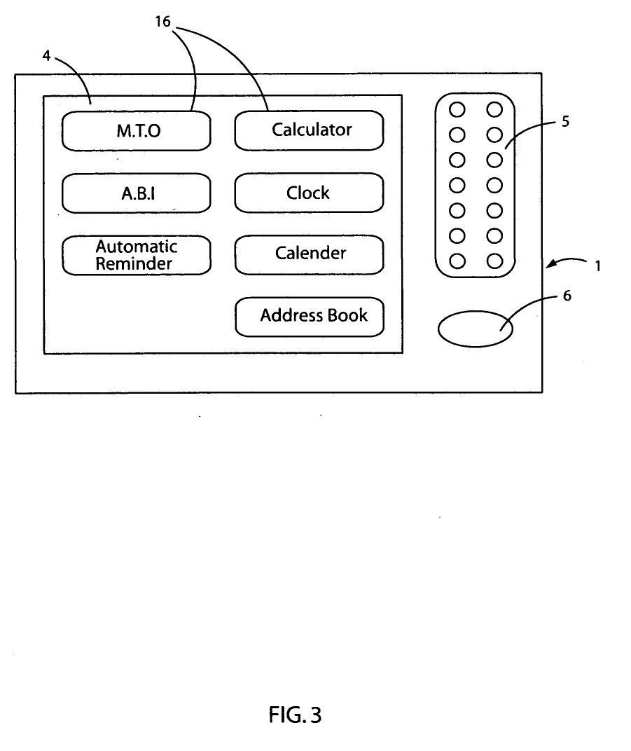

FIG. 4 is substantially a representation of recorded banking information by the voice recorder associated with the invention.

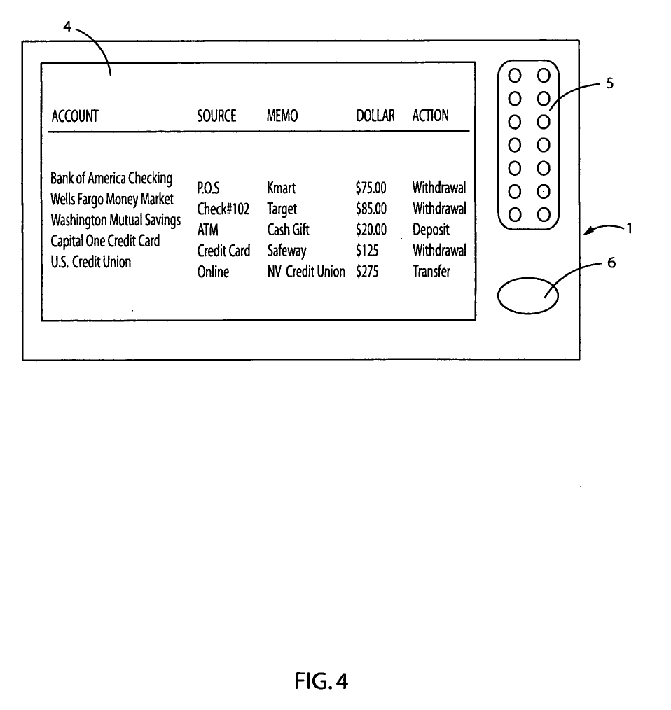

### DESCRIPTION OF CERTAIN EMBODIMENTS OF THE PRESENT INVENTION

In the following detailed description of the preferred embodiment, reference is made to the accompanying drawings, which from a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings and the element that each reference number corresponds to and a brief description:
1. First Panel. The first panel 1 includes an outer surface 2 and inner surface 3 in accordance with the present invention.
2. Outer Surface. This outer surface 2 includes at least one user interfacing area 4, a speaker 5 and at least one button 6.
3. Inner Surface. This includes a plurality of slots 7.
4. User Interfacing Area. This is a digital touch screen 4 that displays at least one option 16.
5. Speaker. This allows the user to speak to record the information regarding the amount spent, withdrawn, deductions, deposits and/or transfers through the voice recorder associated with the device.
6. At least one button. This is an On/Off button 6.
7. A Plurality of Slots. This is designed to hold at least one transaction card 8.
9. At least one transaction card. This may be selected from a group consisting of credit cards, debit cards, visa cards, master cards and smart cards.
10. Second Panel. The second panel 9 includes an inner surface 10.
11. Inner Surface of Second Panel. This surface 10 includes at least one slot 11 and further comprises a slot 13 for holding a pen 14.
12. At least one Slot. The at least one slot 11 is designed to hold at least one transaction document 12.
13. At least one Transaction Document. This may be a check book.
14. At least one Option. This may include manual transaction override, transaction, balance inquiry and automatic reminders.

The present invention comprises a portable electronic device for monitoring and tracking at least one bank account and a plurality of transactions. The invention includes a first panel 1 having an outer surface 2 and an inner surface 3. The outer surface 2 includes at least one user interfacing area 4, a speaker 5 and at least one button 6 to interface with a user and the inner surface 3 includes a plurality of slots 7 designed to hold at least one electronic transaction card 8. The invention further includes a second panel 9 with an inner surface 10 that includes at least one slot 11 for holding at least one transaction document 12. The first panel 1 and the second panel 9 is arranged in face to face relation along a horizontal fold line to make the device compact and easy to operate.

The device can be customized as a unit for singles, a unit for couples and a unit for businesses. The device may optionally be configured to hold a checkbook. The device can be compatible with at least one financial software allowing easy storage of banking records on hard drives. The least one user interfacing area 4 may be a digital touch screen. The at least one button 6 designed to interface with a user may be an On/Off button. Preferably, the at least one electronic transaction card 8 may be selected from a group consisting of credit cards, debit cards, visa cards, master cards and smart cards. Also, the at least one transaction document 12 may be a check book. The second panel further includes at least one slot 13 designed to hold at least one pen 14. The device further includes a voice recorder for recording information regarding amount spent, withdrawn, deductions, deposits and/or transfers. Optionally, the inner surface of the second panel may include a plurality of slots 15 for holding at least one transaction card 8.

As discussed in the background section, while balancing the checkbook of a person can be a tedious process according to the present invention, a compact convenient way to manage bank accounts. The device would be adapted for recording all deductions, deposits, and transfers and also, the device would be customizable to easily recall balance inquiries of different accounts and capable of paging a second device with the updated account information.

The method may include the pressing of an On/Off button 6 to turn on the device, a predetermined set of verification codes that displayed in at least one user interfacing area 4 are selected by the user for authenticating an identity of the user and unlocking the device. The at least one user selects at least one option 16 displayed in the at least one user interfacing area 4 for performing at least one operation. Then the device is closed prompting a ring, beep or vibration to alert the user of the occurrence of a banking transaction. Thus the device may allow the user to speak into a speaker 5 about at least one recent operation that can be recorded in a voice recorder.

The predetermined set of verification codes may include a plurality of images and the images can be three in number. The at least one option 16 displayed in the digital touch screen 4 may be manual transaction override, transaction, balance inquiry and automatic reminders. The device can come in different patterns and colors that can accommodate user preferences. The options, measurements, designs and software can also be varied widely in accordance with the manufacturing of the present invention.

One of the main advantages of this device is that it can electronically document all banking information and the configuration of the device provides the user with a compact, convenient way to manage the bank accounts and monitor the spending. Another advantage of the device of the present invention is that it would easily recall balance inquiries on up to 10 different accounts and is capable of paging a second device with updated account information for individuals with joint accounts.

The device allows the user to automatically log the information regarding an account in the memory of the device thereby the memory acts as a bank register that deducts or adds funds to a respective account. The user may also use the option manual transaction override to record information that does not require physical transaction. A helpful reminder can be accomplished by selecting the option automatic reminder displayed on the digital touch screen and programming all dates and amounts of set of transactions. Thus, the device has a facility to warn the user, on the given date, that a transaction is due and allow the user to view and accept the automatic transaction being mentioned.

In one embodiment, the present invention may be customized as a unit for couples those having joint account. In this embodiment, the device communicates through a paging system. Both the couples may hold the device, when one of them makes a withdrawal or deposit, the device alerts the other one carrying the device. The paging system may operate by a predetermined means that would allow each user to receive updated information only on joint accounts while keeping transactions on individual accounts private.

In another embodiment, the present invention may be customized as a unit for businesses. In this embodiment, the device communicates through a paging system. The primary account holder such as a manager of a company may hold a master device and one or more devices are distributed among the employees so that all spending may be tracked. The master device is the only unit that can get hold all of the account information and balances. All the other devices distributed would not have access to the company information. These devices record and log in all transactions the employees perform, such as buying gas, plane tickets, or meals. These devices with the employees would then page the master device and send all the information to the master device and update the register. Thus all the financial information regarding a company can be updated.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A portable electronic device for monitoring and tracking at least one bank account, the device comprising:
a. a first panel having an outer surface and an inner surface wherein the outer surface includes at least one user interfacing area;
b. a speaker adapted to interface with a user through the user interfacing area; wherein:
i. the portable electronic device is adapted to page a second portable electronic device prompting the second portable electronic device to process one or more banking transactions of the at least one bank account;
ii. the inner surface includes a plurality of slots designed to hold at least one electronic transaction card;

2. The portable electronic device of claim 1, further comprising a second panel with an inner surface that includes at least one slot for holding at least one transaction document; wherein the first panel and the second panel is arranged in face to face relation along a horizontal fold.

3. The portable electronic device of claim 1, wherein the at least one user interfacing area comprises a digital touch screen.

4. The portable electronic device of claim 1 wherein the at least one electronic transaction card is selected from a group consisting of credit cards, debit cards, visa cards, master cards and smart cards.

5. The portable electronic device of claim 1 wherein the at least one transaction document comprises a check book.

6. The portable electronic device of claim 1 wherein the portable electronic device prompts a ring, beep or vibration while closing thereby alerting the user of a banking transaction.

7. The portable electronic device of claim 1 further comprising a USB port connected to the user interfacing area.

8. The portable electronic device of claim 1 wherein the device is compatible with at least one financial software program.

9. The portable electronic device of claim 1 wherein the device further comprising a voice recorder for recording a banking transaction.

10. A method for electronically monitoring and tracking a plurality of transactions using a portable electronic device, the method comprising:
a. authenticating an identity of a user by selecting a predetermined set of verification codes that displayed in at least one user interfacing area for unlocking the device;
b. selecting at least one option displayed in the at least one user interfacing area; and performing at least one operation; wherein the portable electronic device comprises:
i. a first panel having an outer surface and an inner surface wherein the outer surface includes at least one user interfacing area;
ii. a speaker adapted to interface with a user through the user interfacing area; wherein:
1. the portable electronic device is adapted to page a second portable electronic device prompting the second portable electronic device to process one or more banking transactions of the at least one bank account;
2. the inner surface includes a plurality of slots designed to hold at least one electronic transaction card.

11. The method of claim 10 wherein the user interfacing area comprises a digital touch screen.

12. The method of claim 10 wherein the predetermined set of verification codes comprises a plurality of images.

13. The method of claim 10 wherein the device prompts a ring, beep or vibration while closing thereby alerting the user of an update.

14. The method of claim 10 wherein the at least one option includes manual transaction override, transaction, balance inquiry, and automatic reminders.

15. The method of claim 10 wherein the user interfacing area includes options such as a clock, calendar, calculator and address book.
